(19) United States
(12) Patent Application Publication
(10) Pub. No.: US 2007/0245904 A1
(43) Pub. Date: Oct. 25, 2007

(54) Hand-Holdable Egg-Based Food Product and Method of Producing Same

(76) Inventor: Leonard Pinchuk, Miami, FL (US)

Correspondence Address: GORDON & JACOBSON, P.C., 60 LONG RIDGE ROAD, SUITE 407, STAMFORD, CT, 06902, US

(21) Appl. No.: 11/379,608

(22) Filed: Apr. 21, 2006

(51) Int. Cl. A47J 37/06

(52) U.S. Cl. 99/375

(57) ABSTRACT

A hand-holdable egg-based food product (and method of producing same) preferably includes a hand-holdable member having first and second portions. An edible part, which preferably surrounds and is supported by the hand-holdable member first portion, includes a processed egg-based composition that is substantially cooked and has a solid form that substantially retains its shape when warmed. The second portion of the hand-holdable member provides gripping surfaces that can be manually picked up and held by a human hand for handling and eating as desired. The edible part can include at least one additive (e.g., vegetable(s), meat(s), cheese(s), spice(s)) that is mixed with the processed egg-based composition. The processed egg-based composition is preferably realized by mixing a liquid form egg-based composition. Advantageously, the hand-holdable egg-based food product need not be consumed with carbohydrates, can be handled with ease, does not come apart, and is therefore suitable for eating on the run.

### BACKGROUND OF THE INVENTION

1. Field of the Invention

This invention relates broadly to food products. More particularly, this invention relates to egg-based food products and methods of producing same.

2. State of the Art

Increasingly, consumers want fast and easily prepared good-tasting foods to fit a busy lifestyle. Egg sandwiches and other egg-based food products are popular. However, they suffer from the requirement that the egg content be surrounded on at least one side with a food stuff of high carbohydrate content, such as bread, muffin or croissant. Thus, consumers who are generally on a diet typically discard the carbohydrate encapsulate prior to consuming the egg content, which is a messy, wasteful and time-consuming operation. Moreover, picking up the hot contents of the egg sandwich may be uncomfortable to the touch. In addition, the contents of the egg sandwich can at times be unstable and come apart, which makes eating on the run (e.g., in the car) an awkward and messy affair.

Thus, there is a need for an egg-based food product that need not be consumed with carbohydrates, that can be handled with ease, and that does not come apart and is therefore suitable for eating on the run (e.g., while in the car).

### SUMMARY OF THE INVENTION

It is therefore an object of the invention to provide an egg-based food product that need not be consumed with carbohydrates.

It is another object of the invention to provide an egg-based food product that can be handled with ease.

It is a further object of the invention to provide an egg-based food product that does not come apart and is therefore suitable for eating on the run (e.g., while in the car).

In accord with these objects, which will be discussed in detail below, an inventive food product includes a hand-holdable member having a first portion and a second portion, and an edible part that is supported by the first portion of the hand-holdable member. The edible part includes a processed egg-based composition that is substantially cooked. The edible part has a solid form that substantially retains its shape when heated. The second portion of the hand-holdable member provides gripping surfaces that can be manually picked up and held by a human hand for handling and eating as desired. The edible part can include at least one additive mixed with the processed egg-based composition. The processed egg-based composition is preferably realized by mixing a liquid form egg-based composition.

It will be appreciated that the food product of the present invention needs not be consumed with carbohydrates, can be handled with ease, and does not come apart. It is therefore suitable for eating on the run (e.g., while in the car).

According to one embodiment of the invention, the edible part is at least partially cooked within a mold cavity and removed therefrom.

According to another embodiment of the invention, the edible part is realized by cooking a processed egg-based composition and at least one additive outside a mold cavity, processing the resultant cooked mixture into pieces, adding the pieces to a mold cavity with a binder, and cooking the pieces and binder in the mold cavity such that the pieces bind to the first portion of the hand-holdable member.

In another aspect of the invention, a method is provided for producing food stuff, which employs a mold with a mold cavity in addition to a hand-holdable member having a first portion that is supported within said mold cavity and a second portion that is disposed outside said mold cavity. A liquid form processed egg-based composition is added to the mold cavity. Thermal radiation (e.g., heat) is applied to the mold cavity in order to substantially cook the liquid form processed egg-based composition to realize a hand-holdable food product. The hand-holdable food product is then removed from the mold cavity. The hand-holdable food product has an edible part of a solid form that substantially retains its shape when heated, wherein the first portion of the hand-holdable member supports the edible part. The second portion of the hand-holdable member provides gripping surfaces that can be manually picked up and held by a human hand for handling and eating as desired. One or more additives (e.g., vegetable(s), meat(s), cheese(s)) can be mixed with the liquid form processed egg-based composition before the mixture is added to the mold cavity such that said edible part includes the additive(s).

It will be appreciated that the hand-holdable food product of the present invention need not contain carbohydrates, can be handled with ease, and does not come apart. It is therefore suitable for eating on the run (e.g., while in the car).

Additional objects and advantages of the invention will become apparent to those skilled in the art upon reference to the detailed description taken in conjunction with the provided figures.

### BRIEF DESCRIPTION OF THE DRAWINGS

FIG. 1 is a schematic diagram of a two part mold for producing a hand-holdable egg-based food product in accordance with the present invention.

### DETAILED DESCRIPTION

The term “egg-based composition” means any composition that includes liquid eggs, dried eggs, frozen eggs, liquid egg whites, dried egg whites, frozen egg whites, liquid egg yokes, dried egg yolks, and/or frozen egg yokes. Vitamins (such as Vitamin A, Vitamin B-12, Vitamin D, Vitamin E, folic acid and riboflavin) may be added to such egg-based composition for nutritional purposes. An example of such an egg-based composition is sold commercially under the name Eggbeaters by ConAgra Foods of Omaha, Neb., which includes beaten liquid egg whites that are fortified with vitamins and other nutrients. The eggs (or egg portions) of the egg-based composition are preferably from a domestic hen but can be from other birds (e.g., geese or ducks) or possibly from other animals (e.g., snakes, alligators, lizards).

In accordance with the present invention, a hand-holdable egg-based food product is realized from a processed egg-based composition provided in liquid form. The liquid form processed egg-based composition may be realized by i) beating or stirring liquid eggs or liquid egg whites, ii) adding a liquid such as water and/or milk to a powdered egg-based composition (e.g., dried eggs or egg whites) and mixing the resultant mixture, and/or iii) heating a frozen egg-based composition (e.g., frozen eggs or egg whites) and mixing the resultant composition. The mixing substantially homogenizes the eggs (or egg portions) that are part of the liquid form processed egg-based composition. Additional liquid such as water or milk can be added to the liquid form processed egg-based composition for volume.

One or more additives may then be added to the liquid form processed egg-based composition. Exemplary additives include the following:
vegetables such as onions, peppers (green, orange, yellow or red), mushrooms, olives, endives, artichokes, bamboo shoots, and the like;
meats such as fish (lox, white fish), ham, bacon, cornbeef hash, steak, chicken, and the like;
cheeses such as American cheese, cheddar cheese, Swiss cheese and the like;
spices such as salt, pepper and the like;
combinations of the above; and
any of the above (or combinations thereof) that are cooked with an egg-based composition and then diced or chopped.

The resulting mixture of the liquid form processed egg-based composition and one or more additive(s) preferably include at least 25% egg (or egg portions) by weight and most preferably include at least 50% egg (or egg portions) by weight.

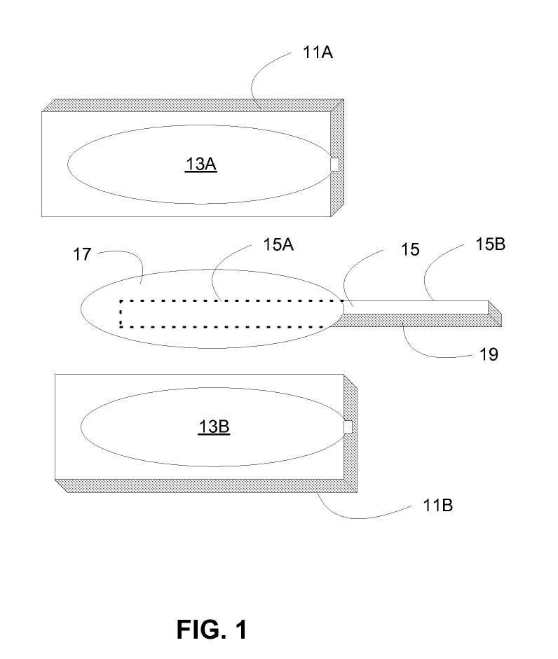

As shown in FIG. 1, a two-part mold 11A, 11B is provided that defines a mold cavity, which is realized by the union of the cutout portions 13A and 13B when the two parts 11A and 11B are secured on top of one another. A hand-holdable member 15 is supported by the mold cavity. The hand-holdable member 15 can be made from wood, metal, plastic or biological food stuff (such as bamboo shoots, celery sticks, toast, sausage, biscuit and the like). The hand-holdable member can be shaped like a popsicle stick or a round rod or the like. A portion 15A of the hand-holdable member is contained within the mold cavity, while the remaining portion 15B is disposed outside the mold cavity. The liquid form processed egg-based composition and the additives (if any) are added to the mold cavity and surround the hand-holdable member portion 15A contained therein. Heat or other form of thermal radiation (such as microwave radiation) is applied to the mold 11A, 11B in order to substantially cook the processed egg-based composition such that it binds itself along with the additives (if any) to the hand-holdable member portion 15A contained in the mold. Preferably, the hand-holdable member portion 15A includes a plurality of holes (not shown) or can be made textured to better bind the cooked egg-based product thereto. The resulting hand-holdable egg-based food product is then removed from the mold as depicted in FIG. 1.

In an additional processing step, the hand-holdable egg-based food product may be placed in an oven at a higher temperature 400-600° F., or on “broil” or over a flame and baked for an additional few minutes to harden the outside of the food product to provide additional structural integrity to the food product. Further, in this hardened condition, it may not be necessary to provide a hand-holdable member as the hardened shell surrounding the food product may be hand-holdable in itself.

The resulting hand-holdable food product includes an edible part 17 that is realized by the cooked processed egg-based composition and additives (if any). The edible part 17 preferably includes at least 25% egg (or egg portions) by weight and most preferably includes at least 50% egg (or egg portions) by weight. The edible part 17 has a solid form and substantially retains its shape when heated to a typical food warming temperature in a range between 100° F. and 175° F. This solid form is bound to, surrounds and is supported by the hand-holdable member portion 15A that was disposed in the mold cavity during the cooking process. The hand-holdable member portion 15B that was disposed outside the mold cavity during the cooking process provides gripping surfaces 19 that can be manually picked up and held by a human hand for handling and eating as desired.

The following examples describe different methods for making the hand-holdable egg-based food product in accordance with the present invention.

### EXAMPLE 1

A mold (11A, 11B) is provided that defines an elongated mold cavity (13A, 13B). A hand-holdable member 15 as described above is supported by the mold cavity. A portion 15A of the hand-holdable member is contained within the mold cavity, while the remaining portion 15B is disposed outside the mold cavity. The hand-holdable member 15 is held in place with a suitable fixture placed within the mold cavity. Preferably, the hand-holdable member 15 is realized by a popsicle stick which is comprised of wood with a plurality of holes (not shown) drilled in the portion 15A. The mold cavity preferably has one end open to air. A liquid egg is beaten (processed) and poured into the mold cavity. A non-stick spray (or liquid) may be applied to the mold cavity before pouring the beaten egg therein. The mold (with the beaten egg and hand-holdable member portion disposed in) is placed in an oven at 100° C. until the egg is cooked as desired (e.g., 30 minutes). During the cooking, the egg expands and bonds to itself through the holes in the hand-holdable member. The resulting hand-holdable egg-based food product is then removed from the mold.

Although the hand-holdable egg-based food product can be eaten immediately, it is preferred that the product be frozen and shipped to a retail establishment (e.g., convenience store or fast food restaurant) where it can be thawed and warmed in a microwave oven and sold to consumers. The resulting hand-holdable food product includes an edible part (17) that is realized by the cooked beaten egg. In this Example 1, the edible part includes substantially 100% egg (or egg portions) by weight. It also has a solid form and substantially retains its shape when heated to a typical food warming temperature in a range between 100° F. and 175° F. This solid form is bound to, surrounds and is supported by the portion 15A of the hand-holdable member that was disposed within the mold cavity during the cooking process. The portion 15B of the hand-holdable member that was disposed outside the mold cavity during the cooking process provides gripping surfaces 19 that can be manually picked up and held by a human hand for handling and eating as desired.

### EXAMPLE 2

A mold (11A, 11B) is provided that defines an elongated mold cavity (13A, 13B). A hand-holdable member 15 as described above is supported by the mold cavity. A portion 15A of the hand-holdable member is contained within the mold cavity, while the remaining portion 15B is disposed outside the mold cavity. The hand-holdable member is held in place with a suitable fixture placed within the mold cavity. Preferably, the hand-holdable member is realized by a popsicle stick which is comprised of wood with a plurality of holes drilled in that portion contained in the mold cavity. The mold cavity preferably employs a lid that seals the mold cavity to enable the mold cavity to be pressurized. A liquid egg is beaten (processed) and poured into the mold cavity. A non-stick spray (or liquid) may be applied to the mold cavity before pouring the liquid egg therein. The mold (with the beaten egg and hand-holdable member portion disposed in) is placed into an oven at 150° C. and heated unit the egg is cooked (e.g., 5 minutes). The egg polymerizes within the pressurized mold, and when cooled, takes the exact shape of the mold. The resulting hand-holdable egg-based food product is then removed from the mold.

As described above with respect to Example 1, the resulting hand-holdable egg-based food product can be eaten immediately, or can be frozen and shipped to a retail establishment (e.g., convenience store or fast food restaurant) where it can be thawed and warmed in a microwave oven and sold to consumers. The resulting hand-holdable food product includes an edible part (17) that is realized by the cooked beaten egg. In this Example 2, the edible part includes substantially 100% egg (or egg portions) by weight. It also has a solid form and substantially retains its shape when heated to a typical food warming temperature in a range between 100° F. and 175° F. This solid form is bound to, surrounds and is supported by the portion 15A of the hand-holdable member that was disposed within the mold cavity during the cooking process. The portion 15B of the hand-holdable member that was disposed outside the mold cavity during the cooking process provides gripping surfaces 19 that can be manually picked up and held by a human hand for handling and eating as desired.

The methodology of Example 2 is advantageous because it enables the manufacturing of a hand-holdable egg-based food product of an exacting geometry, such as a popsicle, an egg-shaped shape, and the like.

### EXAMPLE 3

A mold (11A, 11B) is provided that defines an elongated mold cavity (13A, 13B). A hand-holdable member 15 as described above is supported by the mold cavity. A portion 15A of the hand-holdable member is contained within the mold cavity, while the remaining portion 15B is disposed outside the mold cavity. The hand-holdable member is held in place with a suitable fixture placed within the mold cavity. Preferably, the hand-holdable member is realized by a popsicle stick which is comprised of wood with a plurality of holes drilled in that portion contained in the mold cavity. The mold cavity preferably employs a lid that seals the mold cavity to enable the mold cavity to be pressurized. A liquid egg is beaten (processed) and combined with vegetable additives. The beaten egg and vegetable additives are poured into the mold cavity. A non-stick spray (or liquid) may be applied to the mold cavity before pouring the liquid egg therein. The mold (with the beaten egg, vegetable additives and hand-holdable member portion disposed in) is placed into an oven at 150° C. and heated unit the egg is cooked (e.g., 5 minutes). The egg polymerizes within the pressurized mold, and when cooled, takes the exact shape of the mold. In order to circumvent gravitation affects and density affects that would otherwise cause the vegetables additives to sink to the bottom or rise to the top of the mold, the mold is preferably rolled or spun as it is heated such that the vegetable additives remain dispersed throughout the mold as the product cooks. The resulting hand-holdable egg-based food product is then removed from the mold and heated to 500° F. in an oven for 5 minutes to harden the outside of the hand-holdable egg-based food product.

As described above with respect to Example 1, the resulting hand-holdable egg-based food product can be eaten immediately, or can be frozen and shipped to a retail establishment (e.g., convenience store or fast food restaurant) where it can be thawed and warmed in a microwave oven and sold to consumers. The resulting hand-holdable food product includes an edible part 17 that is realized by the cooked beaten egg and the vegetable additives. In this Example 4, the edible part preferably includes at least 25% egg (or egg portions) by weight and most preferably includes at least 50% egg (or egg portions) by weight. Such variability in egg content is primarily dictated by the amount of vegetable additives combined with the beaten egg. The edible part also has a solid form and substantially retains its shape when heated to a typical food warming temperature in a range between 100° F. and 175° F. This solid form is bound to, surrounds and is supported by the portion 15A of the hand-holdable member that was disposed within the mold cavity during the cooking process. The portion 15B of the hand-holdable member that was disposed outside the mold cavity during the cooking process provides gripping surfaces that can be manually picked up and held by a human hand for handling and eating as desired.

### EXAMPLE 4

A liquid egg is beaten (processed) and combined with one or more vegetable additives. The beaten egg and additives are heated in a conventional skillet on a stove top until the egg is polymerized. The resulting egg/additive composition (e.g., omelet) is diced into small pieces. These small pieces are mixed with a small amount of beaten liquid egg and placed in any of the molds (11A, 11B) described above with a hand-holdable member 15 fixtured in place. Heat is applied to the mold in order to cook the processed egg-based composition such that the chopped pieces bind to the hand-holdable member. In this manner the additives remain evenly dispersed in the resulting hand-holdable egg-based product. The resulting hand-holdable egg-based food product is then removed from the mold.

As described above with respect to Example 1, the resulting hand-holdable egg-based food product can be eaten immediately, or can be frozen and shipped to a retail establishment (e.g., convenience store or fast food restaurant) where it can be thawed and warmed in a microwave oven and sold to consumers. The resulting hand-holdable food product includes an edible part 17 that is realized by the cooked processed egg-based composition and vegetable additives. In this Example 4, the edible part preferably includes at least 25% egg (or egg portions) by weight and most preferably includes at least 50% egg (or egg portions) by weight. Such variability in egg content is primarily dictated by the amount of vegetable additives combined with the beaten egg. The edible part also has a solid form and substantially retains its shape when heated to a typical food warming temperature in a range between 100° F. and 175° F. This solid form is bound to, surrounds and is supported by the portion 15A of the hand-holdable member that was disposed within the mold cavity during the cooking process. The portion 15B of the hand-holdable member that was disposed outside the mold cavity during the cooking process provides gripping surfaces 19 that can be manually picked up and held by a human hand for handling and eating as desired.

Advantageously, the food product of the present invention need not contain carbohydrates, can be handled with ease, and does not come apart. It is therefore suitable for eating on the run (e.g., while in the car).

There have been described and illustrated herein several embodiments of a method of producing a hand-holdable egg-based food product and food products derived therefrom. While particular embodiments of the invention have been described, it is not intended that the invention be limited thereto, as it is intended that the invention be as broad in scope as the art will allow and that the specification be read likewise. Thus, while a mold is preferred used to cook and form the egg-based edible part into its desired solid form, it will be recognized that other articles and methods can be used. Also, while particular mold configurations and heating temperatures have been disclosed, it will be appreciated that others can be used as well. In addition, while particular types of egg-based compositions and additives have been disclosed, it will be understood that other egg-based compositions and additives can be used. It will therefore be appreciated by those skilled in the art that yet other modifications could be made to the provided invention without deviating from its spirit and scope as claimed.

What is claimed is:

1. A food product comprising:
i) a hand-holdable member having a first portion and a second portion; and
ii) an edible part including a processed egg-based composition that is substantially cooked, said edible part having a solid form that substantially retains its shape when heated;
wherein said first portion of said hand-holdable member supports said edible part, and said second portion of said hand-holdable member provides gripping surfaces that can be manually picked up and held by a human hand for handling and eating as desired.

2. A food product according to claim 1, wherein:
the solid form shape of said edible part is retained when said edible part is heated to a temperature in a range between 100° F. and 175° F.

3. A food product according to claim 1, wherein:
said first portion of said hand-holdable member is surrounded by said edible part.

4. A food product according to claim 1, wherein:
said processed egg-based composition is realized by mixing a liquid form egg-based composition.

5. A food product according to claim 1, wherein:
said edible part includes at least one additive mixed with said processed egg-based composition before cooking said egg-based composition.

6. A food product according to claim 5, wherein:
said at least one additive is selected from the group including vegetables, meats, cheeses, spices, and combinations thereof.

7. A food product according to claim 1, wherein:
said hand-holdable member is made from one of wood, metal, plastic, and a biological food stuff.

8. A food product according to claim 1, wherein:
said hand-holdable member is shaped like one of a popsicle stick and a round rod.

9. A food product according to claim 1, wherein:
said edible part includes at least 25% egg (or egg portions) by weight.

10. A food product according to claim 1, wherein:
said edible part includes at least 50% egg (or egg portions) by weight.

11. A food product according to claim 1, wherein:
said edible part is at least partially cooked within a mold cavity and removed therefrom.

12. A food product according to claim 11, wherein:
said edible part is heated at a temperature that hardens the outside of said edible part after the edible part is removed from the mold cavity.

13. A food product according to claim 1, wherein:
said edible part is realized by cooking a processed egg-based composition that is mixed with at least one additive outside said mold cavity, processing the resultant cooked mixture into pieces, adding the pieces to a mold cavity with a binder, and cooking the pieces and binder in the mold cavity such that the pieces bind to the first portion of said hand-holdable member.

14. A food product according to claim 1, wherein:
said egg-based composition comprises egg whites.

15. A food product according to claim 14, wherein:
said egg-based composition comprises at least one vitamin.

16. A food product according to claim 15, wherein:
said at least one vitamin is selected from the group including vitamin A, vitamin B-12, vitamin D, vitamin E, folic acid and riboflavin.

17. A food product comprising:
an edible part including a processed egg-based composition that is substantially cooked, said edible part having a solid form that is shaped by a mold, said solid form substantially retaining its shape when heated, wherein said edible part is heated to harden its outside after being removed from the mold.

18. A food product according to claim 17, wherein:
the edible part is heated to harden its outside by at least one of
i) heating in an oven in a temperature range between 400° F. and 600° F.,
ii) broiling over a flame, and
iii) additional baking.

19. A food product according to claim 17, wherein:
said processed egg-based composition is realized by mixing a liquid form egg-based composition.

20. A food product according to claim 17, wherein:
said edible part includes at least one additive mixed with said processed egg-based composition before cooking said egg-based composition.

21. A food product according to claim 20, wherein:
said at least one additive is selected from the group including vegetables, meats, cheeses, spices, and combinations thereof.

22. A food product according to claim 17, wherein:
said edible part includes at least 25% egg (or egg portions) by weight.

23. A food product according to claim 17, wherein:
said edible part includes at least 50% egg (or egg portions) by weight.

24. A method of producing food stuff including:
providing a mold with a mold cavity in addition to a hand-holdable member having a first portion that is disposed within said mold cavity and a second portion that is disposed outside said mold cavity;
adding at least a liquid form processed egg-based composition to said mold cavity;
applying thermal radiation to said mold cavity in order to substantially cook said liquid form processed egg-based composition to realize a hand-holdable food product, said hand-holdable food product having an edible part of a solid form that substantially retains its shape when heated, wherein said first portion of said hand-holdable member supports said edible part, and said second portion of said hand-holdable member provides gripping surfaces that can be manually picked up and held by a human hand for handling and eating as desired; and
removing said hand-holdable food product from said mold cavity.

25. A method according to claim 24, wherein:
the solid form shape of said edible part is retained when said edible part is heated to a temperature in a range between 100° F. and 175° F.

26. A method according to claim 24, wherein:
said first portion of said hand-holdable member is surrounded by said edible part.

27. A method according to claim 24, wherein:
said liquid form processed egg-based composition is realized by beating or stirring liquid eggs or liquid egg whites.

28. A method according to claim 24, wherein:
said liquid form processed egg-based composition is realized by adding a liquid to a powdered egg-based composition and mixing the resultant mixture.

29. A method according to claim 24, wherein:
said liquid form processed egg-based composition is realized by applying thermal radiation to a frozen egg-based composition and mixing the resultant composition.

30. A method according to claim 24, wherein:
said liquid form processed egg-based composition includes liquid selected from the group of water and milk for added volume.

31. A method according to claim 24, wherein:
at least one additive is mixed with said liquid form processed egg-based composition before the mixture is added to said mold cavity such that said edible part includes said at least one additive.

32. A method according to claim 31, wherein:
said at least one additive is selected from the group including vegetables, meats, cheeses, spices, and combinations thereof.

33. A method according to claim 24, wherein:
said hand-holdable member is made from one of wood, metal, plastic, a biological food stuff.

34. A method according to claim 24, wherein:
said hand-holdable member is shaped like one of a popsicle stick and a round rod.

35. A method according to claim 24, wherein:
said edible part includes at least 25% egg (or egg portions) by weight.

36. A method according to claim 24, wherein:
said edible part includes at least 50% egg (or egg portions) by weight.

37. A method according to claim 24, wherein:
said mold cavity is sealable for pressurized cooking therein.

38. A method according to claim 31, wherein:
said mold is moved during cooking to ensure mixing of the at least one additive within the mold cavity during cooking.

39. A method according to claim 24, further comprising:
cooking a processed egg-based composition mixed with at least one additive outside the mold cavity;
processing the resultant cooked mixture into pieces;
adding to the mold cavity the pieces together with the liquid form processed egg-based composition used as a binder; and
cooking the pieces and the binder in the mold cavity such that the pieces bind to the first portion of said hand-holdable member, said pieces being part of the edible part of said hand-holdable food product.

40. A method of producing food stuff including:
providing a mold with a mold cavity;
adding at least a liquid form processed egg-based composition to said mold cavity;
applying thermal radiation to said mold cavity in order to substantially cook said liquid form processed egg-based composition to realize an edible part, said edible part having a solid form that substantially retains its shape when heated;
removing said edible part from said mold cavity; and
subsequent to the removing, heating said edible part to harden its outside.

41. A food product according to claim 40, wherein:
the edible part is heated to harden its outside by at least one of
i) heating in an oven in a temperature range between 400° F. and 600° F.,
ii) broiling over a flame, and
iii) additional baking.

42. A method according to claim 40, further comprising:
mixing at least one additive with said liquid form processed egg-based composition before the mixture is added to said mold cavity such that said edible part includes said at least one additive.

43. A method according to claim 42, wherein:
said at least one additive is selected from the group including vegetables, meats, cheeses, spices, and combinations thereof.
